(19) United States
(12) Patent Application Publication
(10) Pub. No.: US 2007/0282633 A1
(43) Pub. Date: Dec. 6, 2007

(54) User and patient specific extraction and display of medical data from electronic health records

(75) Inventors: Sultan Haider, Erlangen (DE); Michael Mankopf, Mohrendorf (DE)

Correspondence Address: SCHIFF HARDIN, LLP;PATENT DEPARTMENT, 6600 SEARS TOWER, CHICAGO, IL, 60606-6473, US

(73) Assignee: Siemens Aktiengesellschaft

(21) Appl. No.: 11/447,504

(22) Filed: Jun. 5, 2006

(51) Int. Cl. G06F 19/00; G05B 13/02

(52) U.S. Cl. 705/3; 700/47

(57) ABSTRACT

In a method for extraction and display of medical data for a specific medical problem of a specific patient, an electronic health record data base is provided having a plurality of health records for a plurality of patients. A user index and rules data base is provided storing a plurality of health care professional user specific profiles, and also rules for controlling a retrieval engine. A patient index is provided storing patient demographic information along with medical problem codes for a plurality of patients. The retrieval engine is connected with a display. With the retrieval engine, data from the electronic health data base is retrieved for the specific patient and for the specific medical problem according to a specific healthcare professional user profile and according to the medical problem codes stored in the patient index. A behavior of the retrieval engine is controlled by the rules stored in the user index and rules data base. With the display, a chart shows relevant medical information for the specific medical problem of the specific patient.

### BACKGROUND

Data collected in comprehensive patient health records contains a growing volume of medical information provided by healthcare professionals, institutions and patients themselves. Review of these records and searching for relevant information can result in a significant effort by the healthcare professional, for example, a physician or general practitioners. Typically only a small subset of the data is relevant to support diagnosis and decisions for further treatment of the patient. The information required typically depends on existing (long-term) diagnosis of a patient and the individual needs of the physician.

### SUMMARY

It is an object to provide an efficient method and system to display specific required patient information in a condensed, for example one-page, overview to significantly reduce the effort and improve the effectiveness of an electronic health record review and help supporting efficiency and quality of care.

In a method for extraction and display of medical data for a specific medical problem of a specific patient, an electronic health record data base is provided having a plurality of health records for a plurality of patients. A user index and rules data base is provided storing a plurality of health care professional user specific profiles, and also rules for controlling a retrieval engine. A patient index is provided storing patient demographic information along with medical problem codes for a plurality of patients. The retrieval engine is connected with a display. With the retrieval engine, data from the electronic health data base is retrieved for the specific patient and for the specific medical problem according to a specific healthcare professional user profile and according to the medical problem codes stored in the patient index. A behavior of the retrieval engine is controlled by the rules stored in the user index and rules data base. With the display, a chart shows relevant medical information for the specific medical problem of the specific patient.

### BRIEF DESCRIPTION OF THE DRAWING

FIG. 1 illustrates a system and method for user and patient specific extraction of medical data from electronic health records and presentation of the extracted medical data as a convenient chart style overview.

### DESCRIPTION OF THE PREFERRED EMBODIMENT

For the purposes of promoting an understanding of the principles of the invention, reference will now be made to the preferred embodiment illustrated in the drawing and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

With the method and system of the preferred embodiment, user and patient specification extraction of medical data is provided from so-called longitudinal electronic health records. The term “longitudinal electronic health record” is intended to mean a patient record which is lengthy as a result of a long medical history of the patient, such record including many different kinds of patient historical and event information. With the system and method of the preferred embodiment, the extracted medical data is presented in a so-called cockpit-chart style overview focusing on information relevant for medical diagnosis and further treatment. The term “cockpit-chart style” is intended to mean a convenient chart style presentation which allows for a quick overview of the extracted medical information focusing on certain specific information relevant to a certain specific diagnostic question or questions.

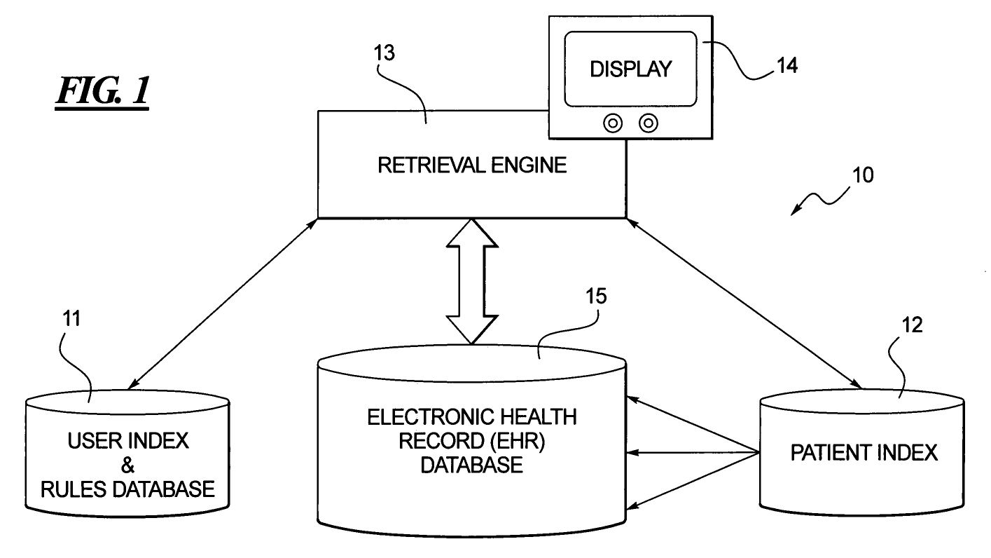

As shown in FIG. 1, the system and method 10 of the preferred embodiment comprises a user index and rules database 11 storing user (healthcare professional) specific profiles; a patient index 12 storing patient demographic information along with leading diagnosis codes; a retrieval engine 13; a display module 14; and an EHR (Electronic Health Record) database 15 storing the longitudinal electronic health records of patients.

The system 10 maintains a user profile which is stored in the user index 11. The user profile comprises information on the type and display method of healthcare data by specific types for a specific disease main diagnosis. Profile data is used to control the behavior of the retrieval engine 13 and display 14 of the system 10. Initial profiles of new users are stored in user index 11 and are set according to predefined templates and then over time are adapted to the user's specific needs and behavior. The adapted templates are also stored in user index 11.

The patient index 12 stores patient identifying data as well as main diagnoses, for example in diagnosis code form. The patient index 12 is also part of an EHR solution, for example, an EHR master patient index system.

The retrieval engine 13 retrieves data from the EHR record in data base 15 according to the user's profile and the diagnosis codes stored in the patient index 12. The behavior of the retrieval engine 13 is controlled by rules stored in the user index 11. The rules are implemented by use of self learning and training algorithms such as Artificial Neural Network, Bayesian, Genetic algorithm etc. with new rules being definable based on user preferences.

Data is displayed in a cockpit-chart on display 14 assembling all relevant medical information for at least one specific disease main diagnosis for a particular patient. Details of the entire health record can be reviewed in a second step if necessary. The type of display elements in the cockpit-chart is disease and/or diagnosis specific and also depends on user preferences stored in the user index 11.

With the system and method, an efficient display is provided of relevant medical information. This reduces the effort to browse entire health record information, and increases productivity and acceptance of EHR solutions. The complexity of retrieval of relevant medical information is reduced from the large amount of data stored in longitudinal electronic health records. The system provides a knowledge support tool for healthcare. Improvement of the quality of care results and an improvement of productivity of healthcare professionals is provided.

While a preferred embodiment has been illustrated and described in detail in the drawing and foregoing description, the same is to be considered as illustrative and not restrictive in character, it being understood that only the preferred embodiment has been shown and described and that all changes and modifications that come within the spirit of the invention both now or in the future are desired to be protected.

We claim as our invention:

1. A system for extraction and display of medical data for a specific medical problem of a specific patient, comprising:
an electronic health record data base having a plurality of health records for a plurality of patients;
a user index and rules data base storing a plurality of healthcare professional user specific profiles and rules for controlling a retrieval engine;
a patient index storing patient demographic information along with medical problem codes for a plurality of patients;
the retrieval engine being connected to said user index and rules data base, electronic health record data base, and patient index, said retrieval engine retrieving data from the electronic health record data base for said specific patient and for said specific medical problem according to a specific healthcare professional user profile and according to said medical problem codes stored in said patient index, a behavior of said retrieval engine being controlled by said rules stored in said user index and rules data base; and
a display connected to said retrieval engine which displays data in a chart format assembling relevant medical information for said specific medical problem of said specific patient.

2. A system of claim 1 wherein said rules stored in said user index and rules data base are implemented in said retrieval engine by use of self learning and training algorithms.

3. A system of claim 2 wherein said self learning and training algorithms comprise artificial neural network, Bayesian, or genetic algorithm types.

4. A system of claim 1 wherein new rules are definable which are stored in said user index and rules data base.

5. A system of claim 1 wherein initial profiles of new users in said user index and rules data base are set according to predefined templates which are adapted over time to the healthcare professional user's specific needs and behaviors.

6. A system of claim 1 wherein said display displays in addition to said chart at least one additional chart comprising further details of said specific patient's health record.

7. A system of claim 1 wherein said medical problem codes comprise diagnosis codes.

8. A system of claim 1 wherein said specific medical problem comprises a diagnosis.

9. A system of claim 8 wherein said diagnosis comprises a disease diagnosis.

10. A system for extraction and display of medical data for a specific medical problem of a specific patient, comprising:
an electronic health record data base having a plurality of health records for a plurality of patients;
a user index and rules data base storing a plurality of healthcare professional user specific profiles and rules for controlling a retrieval engine;
a patient index storing patient demographic information for a plurality of patients;
the retrieval engine being connected to said user index and rules data base, electronic health record data base, and patient index, said retrieval engine retrieving data from the electronic health record data base for said specific patient and for said specific medical problem according to a specific healthcare professional user profile, a behavior of said retrieval engine being controlled by said rules stored in said user index and rules data base; and
a display connected to said retrieval engine which displays data in a chart format in which relevant medical information is assembled for said specific medical problem of said specific patient.

11. A method for extraction and display of medical data for a specific medical problem of a specific patient, comprising the steps of:
providing an electronic health record data base having a plurality of health records for a plurality of patients;
providing a user index and rules data base storing a plurality of health care professional user specific profiles and rules for controlling a retrieval engine;
providing a patient index storing patient demographic information along with medical problem codes for a plurality of patients;
providing a display connected to the retrieval engine; and
with the retrieval engine, retrieving data from the electronic health data base for a said specific patient and for said specific medical problem according to a specific healthcare professional user profile, controlling a behavior of said retrieval engine by said rules stored in said user index and rules data base, and displaying on said display in chart format assembled relevant medical information for said specific medical problem of said specific patient.

12. A method of claim 11 including implementing said rules by use of self learning and training algorithms.

13. A method of claim 11 wherein new rules are definable which are stored in said user index and rules data base based on user preferences.

14. A method of claim 11 wherein initial profiles of new users in said user index and rules data base are set according to predefined templates and adapted over time to the healthcare professional user's specific needs and behaviors.

15. A method of claim 11 wherein said medical problem codes comprises diagnosis codes.

16. A method of claim 11 wherein said specific medical problem comprises a diagnosis.

17. A method of claim 16 wherein said diagnosis comprises a disease diagnosis.

18. A method for extraction and display of medical data for a specific medical problem of a specific patient, comprising the steps of:
providing an electronic health record data base having a plurality of health records for a plurality of patients;
providing a user index and rules data base storing a plurality of health care professional user specific profiles and rules for controlling a retrieval engine;
providing a patient index storing patient demographic information for a plurality of patients;
providing a display connected to the retrieval engine; and
with the retrieval engine, retrieving data from the electronic health data base for said specific patient and for said specific medical problem according to a specific healthcare professional user profile, controlling a behavior of said retrieval engine by said rules stored in said user index and rules data base, and displaying on said display in chart format assembled relevant medical information for said specific medical problem of said specific patient.

19. A computer program product for extraction and display of medical data for a specific medical problem of a specific patient, an electronic health record data base being provided having a plurality of health records for a plurality of patients, a user index and rules data base being provided storing a plurality of health care professional user specific profiles and rules for controlling a retrieval engine, a patient index being provided storing patient demographic information for a plurality of patients, and a display being provided connected to said retrieval engine, said computer program product performing the steps of:
retrieving data with the retrieval engine from the electronic health data base for said specific patient and for said specific medical problem according to a specific healthcare professional user profile, controlling a behavior of said retrieval engine by said rules stored in said user index and rules data base, and displaying on said display a chart with assembled relevant medical information for said specific medical problem of said specific patient.
